(19) United States
(12) Patent Application Publication
(10) Pub. No.: US 2026/0143246 A1
(43) Pub. Date: May 21, 2026

(54) SYSTEM AND METHOD FOR AUTOMATIC CONTROL OF MULTIPLE CAMERAS

(71) Applicant: AVer Information Inc., New Taipei City (TW)

(72) Inventors: Wei-Chun TSAI, New Taipei City (TW); Sen-Chiao CHANG, New Taipei City (TW); Chih-Tsung CHIANG, New Taipei City (TW); Tang-Yu CHENG, New Taipei City (TW)

(21) Appl. No.: 19/394,867

(22) Filed: Nov. 19, 2025

(30) Foreign Application Priority Data
Nov. 20, 2024 (TW) 113144747

(51) Int. Cl. H04N 23/90; G06F 3/01; H04N 23/611

(52) U.S. Cl. CPC H04N 23/90; H04N 23/611; G06F 3/017

(57) ABSTRACT

A method for automatic control of multiple cameras includes steps as follows. Cameras capture a person and an object to obtain person information of the person and object information of the object. The cameras include a main camera and a secondary camera; the main camera detects whether the person and the object are in physical contact; when the main camera detects that the person and the object are in physical contact, one of the cameras is selected for image capturing based on the person information, and a first control parameter is used for image capturing based on the person information and the object information; and when the person information changes, another one of the plurality of cameras is selected for image capturing, and a second control parameter is used for image capturing based on the person information and the object information.

### CROSS-REFERENCE TO RELATED APPLICATION

This application claims priority to Taiwan Application Serial Number 113144747, filed Nov. 20, 2024, which is herein incorporated by reference in its entirety.

### BACKGROUND

### Technical field

The present invention relates to a system and a method for automatic control of multiple cameras.

### Description of Related Art

Broadcast production is accomplished by a team composed of multiple individuals with different roles; a camera crew is configured with multiple camera operators, each assigned specific tasks to capture various exciting shots on site. The broadcast director, as the heart and soul of the broadcast production, is responsible for monitoring shooting angles from each camera operator and switching to appropriate shots. Compared to today's increasingly popular personal live streaming, this requires substantial manpower and material costs.

Additionally, single-camera shooting yields relatively monotonous effects and has multiple visual blind spots. Commercially available automatic broadcasting machines require manual machine operation, preventing a single operator from completing all shooting procedures.

To address the problem that personal live streaming that is popular nowadays cannot, like traditional camera crews, utilize substantial manpower and material resources to accomplish program shooting, those skilled in the art are endeavouring to find solutions. However, a suitable method has not been successfully developed for a long time. Therefore, how to achieve capturing with a plurality of cameras and camera movement control in an automated manner is indeed one of the important research and development topics at present, and has also become an objective that urgently needs to be improved in relevant fields.

### SUMMARY

The present invention provides a system and a method for automatic control of multiple cameras to address the problems of the prior art.

In some embodiments of the present invention, the method for automatic control of multiple cameras proposed in the present invention comprises the following steps: capturing, by a plurality of cameras, a person and an object to obtain person information of the person and object information of the object, wherein the plurality of cameras comprise a main camera and at least one secondary camera; detecting, by the main camera, whether the person and the object are in physical contact; when the main camera detects that the person and the object are in physical contact, selecting one of the plurality of cameras for image capturing based on the person information, and using a first control parameter for image capturing based on the person information and the object information; and when the person information changes, selecting another one of the plurality of cameras for image capturing, and using a second control parameter for image capturing based on the person information and the object information, wherein the second control parameter is different from the first control parameter.

In some embodiments of the present invention, the system for automatic control of multiple cameras proposed in the present invention comprises a plurality of cameras comprising a main camera and at least one secondary camera which are communicatively connected with each other, wherein the plurality of cameras capture a person and an object to obtain person information of the person and object information of the object; the main camera detects whether the person and the object are in physical contact; when the main camera detects that the person and the object are in physical contact, the main camera selects one of the plurality of cameras for image capturing based on the person information, and uses a first control parameter for image capturing based on the person information and the object information; and when the person information changes, the main camera selects another one of the plurality of cameras for image capturing, and uses a second control parameter for image capturing based on the person information and the object information, wherein the second control parameter is different from the first control parameter.

In summary, the technical solution of the present invention has obvious advantages and beneficial effects compared with the prior art. By means of the method and the system for automatic control of multiple cameras according to the present invention, capturing with a plurality of cameras and camera movement control can be achieved in an automated manner, thereby completing capture of an entertaining video. By using the plurality of cameras to capture the person and the object to obtain the person information and the object information, an optimal shot for a current scenario can be captured automatically. This automatically achieves tasks that previously required multiple persons, thereby reducing substantial manpower and material costs.

The above description will be described in detail below by way of embodiments, and further explanation of the technical solution of the present invention will be provided.

### BRIEF DESCRIPTION OF THE DRAWINGS

To make the above and other objectives, features, advantages and embodiments of the present invention more apparent and comprehensible, the accompanying drawings are described as follows:

FIG. 1 is a block diagram of a system for automatic control of multiple cameras according to some embodiments of the present invention;

FIG. 2 is a flow chart of a method for automatic control of multiple cameras according to some embodiments of the present invention;

FIG. 3 is a flow chart of a method for automatic control of multiple cameras according to some embodiments of the present invention;

FIG. 4 is a schematic diagram of the method for automatic control of multiple cameras according to some embodiments of the present invention;

FIG. 5 is a schematic diagram of the method for automatic control of multiple cameras according to some embodiments of the present invention; and

FIG. 6 is a schematic diagram of the method for automatic control of multiple cameras according to some embodiments of the present invention.

### DETAILED DESCRIPTION

In order to make the description of the present invention more detailed and comprehensive, reference may be made to the accompanying drawings and various embodiments described below, and the same reference numerals in the drawings represent the same or similar elements. On the other hand, well-known elements and steps are not described in detail in the embodiments to avoid unnecessary limitations on the present invention.

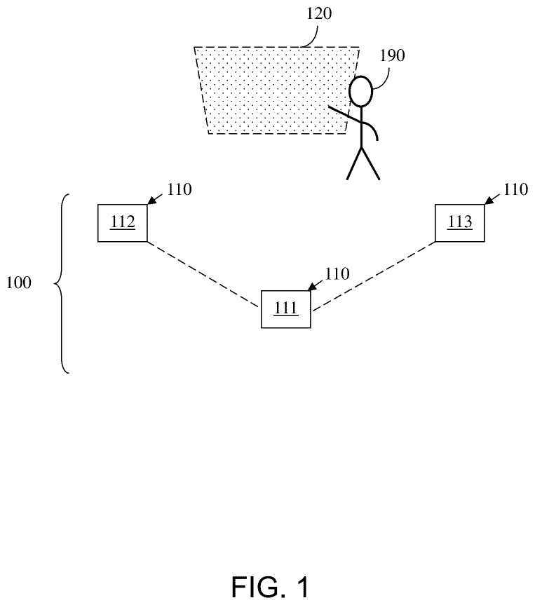

FIG. 1 is a block diagram of a system 100 for automatic control of multiple cameras according to some embodiments of the present invention. As shown in FIG. 1, the system 100includes a plurality of cameras 110 distributed at different locations to capture images from varying perspectives. In some embodiments, any one of the plurality of cameras 110 may be a PTZ camera (Pan-Tilt-Zoom camera), a wide-angle camera, or any combination thereof.

Structurally, the plurality of cameras 110 include a main camera 111 and secondary cameras 112 and 113 which are communicatively connected to each other. For example, the main camera 111 is communicatively connected to the secondary camera 112, and the secondary camera 113 is communicatively connected to the main camera 111. It should be understood that although FIG. 1 shows the two secondary cameras 112 and 113, this does not limit the present invention. In practice, the number of the secondary camera may be one or more. During use, the main camera 111 and the secondary cameras 112 and 113 may simultaneously capture a person 190 and an object 120, and the main camera 111 performs subsequent calculations and analysis. For example, the object 120 may be a display device, such as an electronic display screen, a whiteboard, a blackboard, or a poster.

In practice, for example, the main camera 111 may include an image capturing device, a communication device, a processor, and a storage device which are electrically connected to each other. The communication device of the main camera 111 establishes wired or wireless communication with the secondary cameras 112 and 113. The storage device of the main camera 111 stores program instructions and/or artificial intelligence models. The processor of the main camera 111 executes the program instructions and/or the artificial intelligence models to process and analyze images of the plurality of cameras 110. The communication device of the main camera 111 outputs the processed images to other devices (e.g., a receiving end device for network live streaming). Alternatively, the main camera 111 may include an image capturing device, a communication device, and an external device (e.g., a computing device) which are electrically connected to each other. The external device has the aforementioned processor and storage device, the functions of which will not be redundantly described. For example, using an external computing device to receive, process, and analyze images from the plurality of cameras 110. The secondary cameras 112 and 113 may have the same hardware architecture as the main camera 111 or a simplified hardware architecture.

When in use, the plurality of cameras 110 capture the person 190 and the object 120 to obtain person information of the person 190 (e.g., a face orientation, a body orientation, etc.) and object information of the object 120 (e.g., a movement amount of the object 120, etc.). The main camera 111 detects whether the person 190 and the object 120 are in physical contact. When the main camera 111 detects that the person 190 and the object 120 are in physical contact, the main camera 111 selects one of the plurality of cameras 110 (e.g., the secondary camera 112) for image capturing based on the person information, and uses a first control parameter for image capturing based on the person information and the object information. When the person information changes, the main camera 111 selects another one of the plurality of cameras 110 for image capturing based on the person information, and uses a second control parameter for image capturing based on the person information and the object information, where the second control parameter is different from the first control parameter. In this way, the system 100 can achieve capturing with the plurality of cameras 110 and camera movement control in an automated manner, thereby completing capture of an entertaining video. By using the plurality of cameras 110 to capture the person and the object to obtain the person information and the object information, an optimal shot for a current scenario can be captured automatically. This automatically achieves tasks that previously required multiple persons, thereby reducing substantial manpower and material costs.

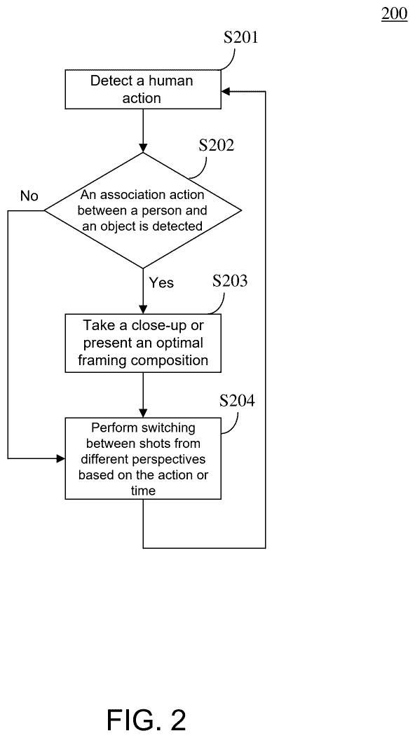

To provide a more specific description of an control method of the system 100, reference is concurrently made to FIGS. 1-2. FIG. 2 is a flow chart of a control method 200 for automatic control of multiple cameras according to some embodiments of the present invention. It should be understood that regarding the steps described in the embodiments of FIG. 2, unless explicitly specifying a sequence, the steps may be adjusted in order according to actual needs, and may be executed simultaneously or partially simultaneously. In practice, for example, the control method 200 may be executed by the system 100. For example, the main camera 111 coordinates with the secondary cameras 112 and 113 to execute the control method 200.

In the control method 200, the plurality of cameras 110 capture a person and an object to obtain person information of the person 190 and object information of the object 120, where the plurality of cameras 110 include a main camera 111 and at least one secondary camera (e.g., the secondary camera 112 and/or the secondary camera 113); the main camera 111 detects whether the person 190 and the object 120 are in physical contact; when the main camera detects that the person and the object are in physical contact, one of the plurality of cameras 110 is selected for image capturing based on the person information, and a first control parameter is used for image capturing based on the person information and the object information; and when the person information changes, another one of the plurality of cameras 110 is selected for image capturing based on the person information, and a second control parameter is used for image capturing based on the person information and the object information, where the second control parameter is different from the first control parameter. In this way, according to the control method 200, the person 190 and the object 120 can be captured with a plurality of cameras 110 to obtain an association between the person 190 and the object 120, and then different camera movement controls and multi-camera shot switching are performed based on the association.

In some embodiments, the person information of the person 190 may include an action type, a face orientation, a body orientation, a position, or any combination thereof. In some embodiments, the object information of the object 120 may include a size, a position, a movement amount, a type, display content, or any combination thereof. In some embodiments, the physical contact may include hand holding, handwriting, finger pointing at display content, or any combination thereof.

In some embodiments, any one of the first control parameter and the second control parameter includes a PTZ value for composition, where PTZ is an abbreviation of Pan (horizontal movement)/Tilt (vertical movement)/Zoom (zoom). For example, the first control parameter is a PTZ value of the selected one of the plurality of cameras 110, and the second control parameter is a PTZ value of the another selected one of the plurality of cameras 110. The second control parameter is different from the first control parameter, this enables capturing with the plurality of cameras and camera movement control to be achieved, thereby completing capture of an entertaining video.

In some embodiments, when the main camera 111 detects that the person and the object are not in physical contact, or when the person information or the object information does not change after a predetermined period of time, switching to the another one of the plurality of cameras for image capturing or using a third control parameter for image capturing by the one of the plurality of cameras is performed, where the third control parameter is different from the first and second control parameters to avoid monotony of the shots.

As shown in FIGS. 1 and 2, in step S201, the main camera 111 and the secondary cameras 112 and 113 simultaneously perform capturing, and detect, via artificial intelligence (AI) (e.g., a trained AI model), the person 190 and actions thereof, along with the object 120 (AI human detection, TV/blackboard and whiteboard detection, TV display action detection). In step S202, it is determined whether an association action between the person 190 and the object 120 is detected. In step S203, a close-up (e.g., a close-up of the person 190 and/or the object 120) is taken or an optimal framing composition is presented. In step S204, switching between shots from different perspectives is performed based on the action or time.

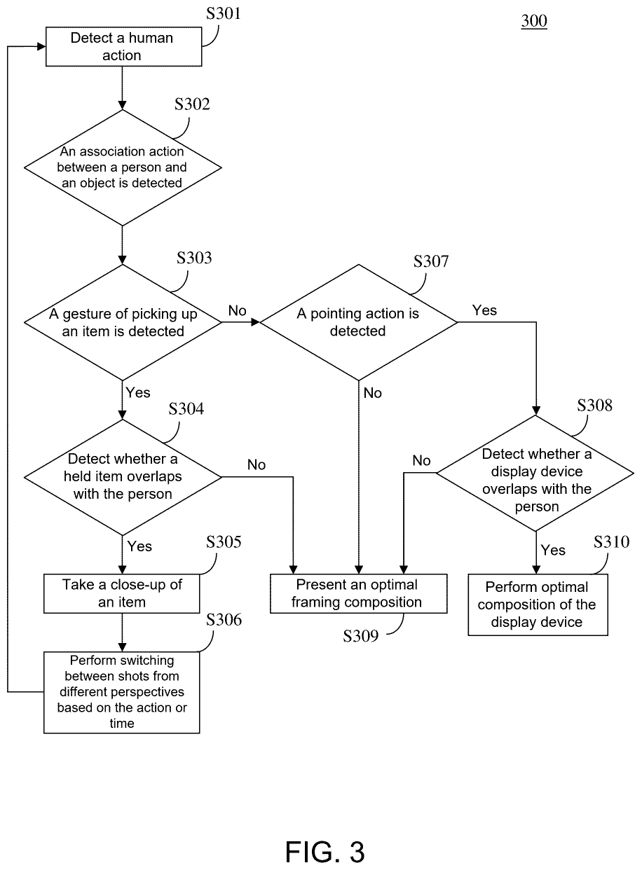

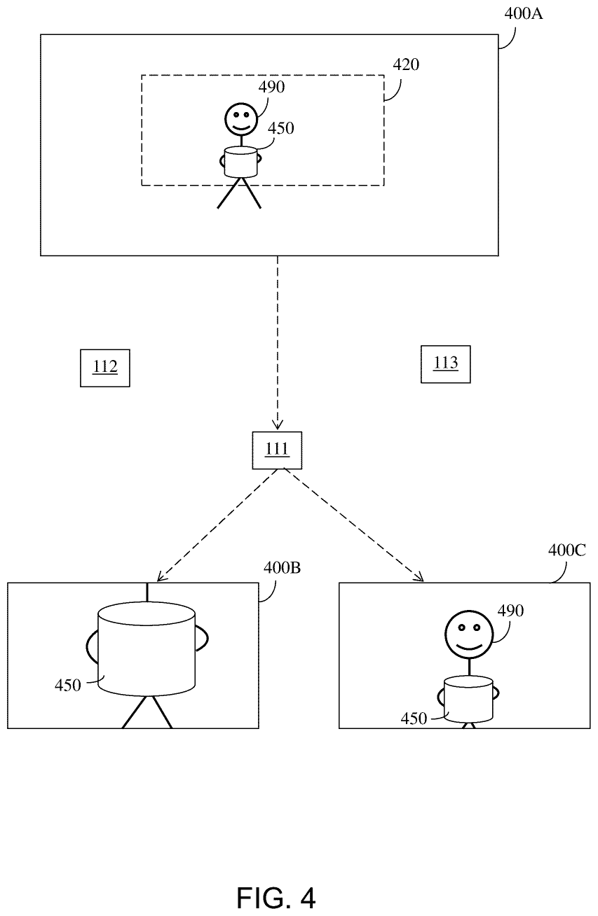

To provide a more specific description of the operation method of the system 100, reference is concurrently made to FIGS. 1-6. FIG. 3 is a flow chart of a control method 300 according to some embodiments of the present invention, and FIGS. 4 to 6 are schematic diagrams of the control method 300 according to some embodiments of the present invention. It should be understood that regarding the steps described in the embodiments of FIG. 3, unless explicitly specifying a sequence, the steps may be adjusted in order according to actual needs, and may be executed simultaneously or partially simultaneously. In practice, for example, the control method 300 may be executed by the system 100. For example, the main camera 111 coordinates with the secondary cameras 112 and 113 to execute the control method 300.

As shown in FIGS. 3 and 4, in step S301, the main camera 111 and the secondary cameras 112 and 113 simultaneously perform capturing, and detect, via artificial intelligence (AI) (e.g., a trained AI model), a person 490 and objects 420 and 450. In step S302, an association action between the person 490 and the objects 420 and 450 are detected.

Specifically, a definition of detecting an association action between a person and an object is that the person 190 needs to be in physical contact with the object (e.g., an item), such as holding the item. Depending on the context, users can specify or exclude specific objects or actions (e.g., holding a microphone, pointing, touching a display device, or writing, and an area of the action must overlap with the content display device) through settings or automatically through artificial intelligence learning (e.g., a trained AI model).

In addition, a movement amount of the object can be detected selectively through continuous images captured by any one of the plurality of cameras 110 to determine whether the object is a real object (e.g., a held item) or a background scene. In some embodiments, as shown in FIG. 4, an image 400A captured by the main camera 111 includes the person 490, the object 420 (e.g., a whiteboard), and the object 450 (e.g., a held item). Since a movement amount of the object 420 (e.g., whiteboard) in the continuous images is zero, the object 420 is determined to be a background scene. Since the object 450 moves along with the hand of the person 490 in the continuous images, the object 450 is determined to be a real object.

As shown in FIG. 3 and FIG. 4, in step S303, a gesture of the person 490 picking up the object 450 (e.g., an item) is detected. In step S304, it is detected whether the held object 450 (e.g., an item) overlaps with the person 490. If so, in step S305, a close-up of the object 450 (e.g., an item) is taken, as shown in an image 400B of FIG. 4. In step S306, switching between shots at different perspectives is performed based on the action or time. For example, switching between the image 400B and an image 400C in FIG. 4 is performed to avoid monotony of the shots.

Regarding the close-up in step S305, for example, with the main camera 111 as a reference, the secondary cameras 112 and 113 performs synchronous capturing for perspective selection. After the person 490 holds the object 450 (e.g., an item) for display for a predetermined period of time, a close-up of the displayed object 450 (e.g., an item) is taken, as shown in the image 400B of FIG. 4.

Regarding the basis for switching perspectives in step S306: switching between shots from different perspectives is performed based on actions or time. If the person 490 does not show any actions (e.g., as determined by an AI model), the person 490 is captured. If the person 490 keeps showing an action: randomly switching between the person 490 or the object 450 (e.g., an item) in close-up is performed. Based on a positional relationship between the person 490 and the object 420 (e.g., a content display device), optimal and suboptimal cameras are determined (e.g., as determined by the AI model). If no action change occurs for a predetermined period of time, automatically switching between optimal and sub-optimal camera perspectives is performed. For example, if the person 490 is facing the main camera 111, the main camera 111 is the optimal camera. If the area of the person 490 captured by the secondary camera 113 is larger than the area of the person 490 captured by the secondary camera 112, the secondary camera 113 is the sub-optimal camera, but the present invention is not limited thereto.

Specifically, in steps S303 to S306, a close-up of a held item is taken: first, the main camera 111 and the secondary cameras 112 and 113 simultaneously perform capturing and detect person information, with the main camera 111 performing action detection and detection of the item in the hand; when it is detected that the person 490 currently makes an action of holding the object 450 (e.g., an item), the size and position of the held object 450 are detected at the same time. After a predetermined period of time (e.g., 2-3 seconds), an item holding mode is entered, and shot switching to a close-up of the image 400B (close-up of the held item) is performed; after approximately another predetermined period of time (e.g., 5-8 seconds), shot switching is performed to bring both the person 490 holding the item and the held object 450 into the shot (selecting the optimal shot perspective based on the direction the person 490 is facing), for example, switching to the image 400C is performed to avoid monotony of the shots.

On the other hand, if it is detected in step S304 that the held object 450 (e.g., an item) does not overlap with the person 490, in step S308, an optimal framing composition is presented. Specifically, when it is detected that the person 490 has put down the object 450, the object holding mode is exited and the process reverts to searching for the optimal framing composition (e.g., the optimal framing composition is determined through the AI model).

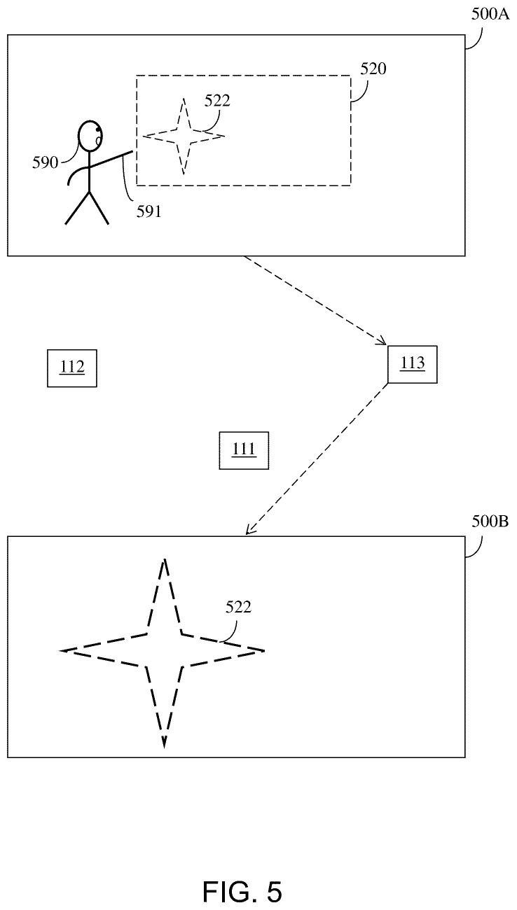

As shown in FIG. 3 and FIG. 5, in step S307, a pointing action is detected. For example, in an image 500A captured by the secondary camera 113, a hand 591 of a person 590 points to a display content 522 of an object 520. In step S308, it is detected whether the object 520 (e.g., a display device) overlaps with the person 590. If not, in step S309, the optimal framing composition (e.g., as determined by the AI model) is presented, as shown in an image 500B. For example, when the person 590 (e.g., presenter) points to the object 520 (e.g., a display device) or turns his back to the main camera 111 and the secondary cameras 112 and 113 (e.g., while writing), the close-up of the display content 522 is prioritized, the secondary camera 113 providing an unobstructed view of the display content 522 is determined as the optimal perspective, and the optimal framing composition presented by the image 500B is purely based on the display content 522.

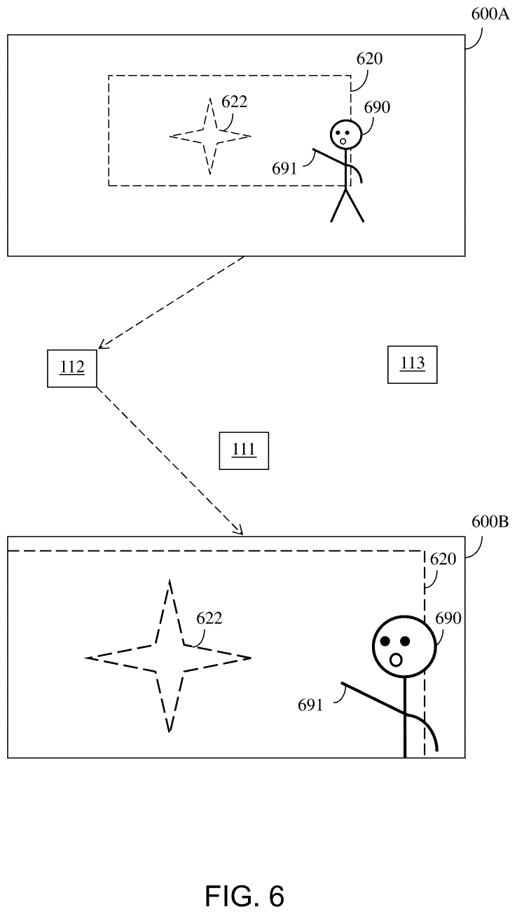

On the other hand, as shown in FIG. 3 and FIG. 6, in step S307, a pointing action is detected. For example, a hand 691 of a person 690 in an image 600A captured by the secondary camera 113 touches an object 620 (e.g., a display device). In step S308, it is detected whether the object 620 (e.g., the display device) overlaps with the person 690. If yes, in step S310, the optimal composition of the display device is performed (e.g., as determined by an AI model), as shown in an image 600B. For example, when the person 690 (e.g., a presenter) is looking at the secondary camera 112, the secondary camera 112 is selected for image capturing based on the relative position of the person 690 (e.g., the presenter) and a display content 622. The secondary camera 112 providing an unobstructed view of the display content 622 is determined as the optimal perspective. The composition is based on the display content 622 and the person 690 (e.g., the presenter) with reference to the relative positional relationship between the person 690 and the object 620 (e.g., left-right position).

As illustrated in FIGS. 3, 5, and 6, the interaction between a person and a display device is as follows: first, the main camera 111 and the secondary cameras 112 and 113 simultaneously perform capturing and detect person information, with the main camera performing action detection and display device detection. When the person is detected to be in a pointing or touching posture, and simultaneously, an overlap between the person and the display device is detected, after being maintained for approximately a predetermined period of time (e.g., 2-3 seconds), a display device interaction mode is entered, and different shot images are switched based on the following scenarios. For example, when the person 590 in FIG. 5 faces the object 520 (e.g., a display device), a close-up of the display content 522 is primary; whereas when the person 690 in FIG. 6 faces the secondary camera 112: the person 690 and the object 620 (e.g., a display device) are simultaneously captured, and the perspective is determined with reference to their relative positions. After being maintained for approximately a predetermined period of time (e.g., 5 to 8 seconds), the images are switched, switching back and forth between the optimal and sub-optimal images (as determined by an AI model) is performed. When it is detected that the person has left the area of the display device, the display device interaction mode is exited, and the process reverts to searching for the optimal framing composition.

In summary, the technical solution of the present invention has obvious advantages and beneficial effects compared with the prior art. By means of the methods 200, 300 and the system 100 according to the present invention, capturing with a plurality of cameras 110 and camera movement control can be achieved in an automated manner, thereby completing the capture of an entertaining video. By using the plurality of cameras 110 to capture the person 190 and the object 120 to obtain the person information and the object information, an optimal shot for a current scenario can be captured automatically. This automatically achieves tasks that previously required multiple persons, thereby reducing substantial manpower and material costs.

Although the present disclosure has been disclosed as above in embodiments, the embodiments are not intended to limit the present disclosure, and those of ordinary skill in the art may make some changes and embellishments within the spirit and scope of the present disclosure, therefore, the scope of protection of the present disclosure shall be defined in the attached claims.

What is claimed is:

1. A method for automatic control of multiple cameras, comprising the following steps:
capturing, by a plurality of cameras, a person and an object to obtain person information of the person and object information of the object, wherein the plurality of cameras comprise a main camera and at least one secondary camera;
detecting, by the main camera, whether the person and the object are in physical contact;
when the main camera detects that the person and the object are in physical contact, selecting one of the plurality of cameras for image capturing based on the person information, and using a first control parameter for image capturing based on the person information and the object information; and
when the person information changes, selecting another one of the plurality of cameras for image capturing, and using a second control parameter for image capturing based on the person information and the object information, wherein the second control parameter is different from the first control parameter.

2. The method according to claim 1, wherein any one of the plurality of cameras is a PTZ camera, a wide-angle camera, or any combination thereof.

3. The method according to claim 1, wherein the person information comprises an action type, a face orientation, a body orientation, a position, or any combination thereof.

4. The method according to claim 1, wherein the object information comprises a size, a position, a movement amount, a type, display content, or any combination thereof.

5. The method according to claim 1, wherein the physical contact comprises hand holding, handwriting, finger pointing at display content, or any combination thereof.

6. The method according to claim 1, further comprising:
detecting a movement amount of the object to determine whether the object is a real object or a background scene.

7. The method according to claim 1, wherein any one of the first control parameter and the second control parameter comprises a PTZ value for composition.

8. The method according to claim 1, further comprising:
when the main camera detects that the person and the object are not in physical contact, or when the person information or the object information does not change after a predetermined period of time, switching to the another one of the plurality of cameras for image capturing, or using a third control parameter for image capturing by the one of the plurality of cameras, wherein the third control parameter is different from the first and second control parameters.

9. The method according to claim 1, further comprising:
pre-specifying or excluding the object through artificial intelligence learning.

10. A system for automatic control of multiple cameras, comprising:
a plurality of cameras comprising a main camera and at least one secondary camera which are communicatively connected with each other, wherein the plurality of cameras capture a person and an object to obtain person information of the person and object information of the object; the main camera detects whether the person and the object are in physical contact; when the main camera detects that the person and the object are in physical contact, the main camera selects one of the plurality of cameras for image capturing based on the person information, and uses a first control parameter for image capturing based on the person information and the object information; and when the person information changes, the main camera selects another one of the plurality of cameras for image capturing, and uses a second control parameter for image capturing based on the person information and the object information, wherein the second control parameter is different from the first control parameter.

11. The system according to claim 10, wherein any one of the plurality of cameras is a PTZ camera, a wide-angle camera, or any combination thereof.

12. The system according to claim 10, wherein the person information comprises an action type, a face orientation, a body orientation, a position, or any combination thereof.

13. The system according to claim 10, wherein the object information comprises a size, a position, a movement amount, a type, display content, or any combination thereof.

14. The system according to claim 10, wherein the physical contact comprises hand holding, handwriting, finger pointing at display content, or any combination thereof.

15. The system according to claim 10, wherein any one of the first control parameter and the second control parameter comprises a PTZ value for composition.
